(19) United States
(12) Patent Application Publication
(10) Pub. No.: US 2020/0207624 A1
(43) Pub. Date: Jul. 2, 2020

(54) METHOD OF PRODUCING CARBON NANOTUBE GROWTH SUBSTRATE

(71) Applicant: HITACHI ZOSEN CORPORATION, Osaka (JP)

(72) Inventor: Naoji MASUHARA, Osaka (JP)

(21) Appl. No.: 16/722,835

(22) Filed: Dec. 20, 2019

(30) Foreign Application Priority Data
Dec. 27, 2018 (JP) 2018-245887
Nov. 22, 2019 (JP) 2019-211579

(51) Int. Cl. C01B 32/162; C01B 32/168

(52) U.S. Cl. CPC C01B 32/162; B82Y 40/00; C01B 2202/00; C01B 32/168

(57) ABSTRACT

An embodiment of the present invention increases the yield of carbon nanotubes per unit area. A method includes the steps of: (a) preparing a first solution containing a siloxane polymer; and (b) forming a silicone coating film on a surface of a base material by applying the first solution to the base material and curing the siloxane polymer.

This Nonprovisional application claims priority under 35 U.S.C. § 119 on Patent Application No. 2018-245887 filed in Japan on Dec. 27, 2018 and Patent Application No. 2019-211579 filed in Japan on Nov. 22, 2019, the entire contents of which are hereby incorporated by reference.

### TECHNICAL FIELD

The present invention relates to a method of producing a carbon nanotube growth substrate, which substrate is for producing carbon nanotubes.

### BACKGROUND ART

In conventional art, producing carbon nanotubes via chemical vapor deposition (CVD) with use of a substrate (i.e., fixed bed CVD) is a known technique. In comparison to fluidized bed CVD, fixed bed CVD enables production of carbon nanotubes which are longer but results in a decreased yield of carbon nanotubes. Means for solving this problem involve, for example, (1) increasing the yield of carbon nanotubes per unit area of the substrate or (2) utilizing a continuous production process to produce the carbon nanotubes.

For example, Patent Literatures 1 and 2 each disclose a technique for producing carbon nanotubes by chemical vapor deposition. In order to achieve a continuous production process for producing carbon nanotubes, these techniques utilize, as a carbon nanotube growth substrate, a thin, roll-like stainless steel foil, the surface of the foil having an intermediate layer and a catalyst layer formed thereon.

### CITATION LIST

### Patent Literature

[Patent Literature 1]

Japanese Patent Application Publication Tokukai No. 2007-70137

[Patent Literature 2]

Japanese Patent Application Publication Tokukai No. 2013-1598

### SUMMARY OF INVENTION

### Technical Problem

However, these conventional techniques utilize a carbon nanotube growth substrate whose intermediate layer is composed of, for example, aluminum, silicon, or silica subjected to alkali etching. Problematically, such a substrate results in a lower yield of carbon nanotubes per unit area (shorter length and lower bulk density of carbon nanotubes) as compared to techniques using only a ceramic base material or glass (quartz) base material.

An object of one aspect of the present invention is to achieve a method of producing a carbon nanotube growth substrate which enables an increased yield of carbon nanotubes per unit area.

### Solution to Problem

In order to solve the above problem, a method of producing a carbon nanotube growth substrate in accordance with an aspect of the present invention includes the steps of: (a) preparing a first solution containing a siloxane polymer; and (b) forming a silicone coating film on a surface of a base material by applying the first solution to the base material and curing the siloxane polymer.

### Advantageous Effects of Invention

An aspect of the present invention makes it possible to produce a carbon nanotube growth substrate which enables an increased yield of carbon nanotubes per unit area.

### BRIEF DESCRIPTION OF DRAWINGS

FIG. 1 shows data regarding conditions and rates of polymerization reactions in Example 1.

FIG. 2 shows data on physical properties of solutions containing siloxane polymer in Example 2.

FIG. 3 shows data on carbon nanotubes grown in Example 2.

### DESCRIPTION OF EMBODIMENTS

A method of producing a carbon nanotube growth substrate in accordance with an aspect of the present invention includes the steps of: (a) preparing a first solution containing a siloxane polymer as a raw material, for forming a silicone coating film having high density on a base material constituted by e.g. a metal (such as stainless steel or copper); and (b) forming the silicone coating film on a surface of the base material by applying the first solution to the base material and curing the siloxane polymer.

### Embodiment 1

The following description will discuss a method of producing a carbon nanotube growth substrate in accordance with one embodiment of the present invention. Note that the phrase “A to B” is used herein to mean “not less than A and not more than B”.

The method of producing a carbon nanotube growth substrate in accordance with Embodiment 1 includes a solution preparation step and a film formation step.

Solution Preparation Step

The solution preparation step is a step of preparing a siloxane polymer solution containing a siloxane polymer (this solution is hereinafter referred to as a “first solution”). The solution preparation step includes a first sub-step and a second sub-step described below.

In the first sub-step when preparing the first solution used in an embodiment of the present invention, firstly, a second solution and a third solution are prepared. The second solution includes a first raw material consisting of an alkoxysilane compound (alkoxysilane compound and alkoxysilane derivative) and/or a low condensate (i.e., a condensate with a low degree of polymerization) of the alkoxysilane compound. The third solution includes a first catalyst, which catalyzes polymerization of the first raw material.

The second solution includes the alkoxysilane compound and/or the low condensate of the alkoxysilane compound (i.e., the first raw material) and a solvent. Possible examples of the alkoxysilane compound include tetramethoxysilane, tetraethoxysilane, tetrapropoxysilane, and tetrabutoxysilane. Possible examples of the low condensate of the alkoxysilane compound include a linear compound (for example, an ethyl silicate oligomer) obtained by condensation of 2 to 20 alkoxysilane units.

The solvent contained in the second solution is not particularly limited provided that it is capable of dissolving the first raw material. Possible examples of this solvent include methanol, ethanol, isopropanol (IPA), n-propanol, n-butanol, ethylene glycol, propylene glycol, ethylene glycol monomethyl ether, ethylene glycol monoethyl ether, ethylene glycol monobutyl ether, propylene glycol monomethyl ether, and dipropylene glycol monomethyl ether.

The third solution contains the first catalyst, water, and a solvent.

The first catalyst is not particularly limited provided that it is capable of catalyzing polymerization of the first raw material. Possible examples of the first catalyst include acid catalysts such as sulfuric acid, hydrochloric acid, nitric acid, and organic acids.

The solvent contained in the third solution is not particularly limited provided that it is capable of dispersing the first catalyst. Possible examples of this solvent include methanol, ethanol, isopropanol (IPA), n-propanol, n-butanol, ethylene glycol, propylene glycol, ethylene glycol monomethyl ether, ethylene glycol monoethyl ether, ethylene glycol monobutyl ether, propylene glycol monomethyl ether, and dipropylene glycol monomethyl ether.

In the first sub-step, the third solution is added to the second solution. This causes the first raw material to react with water in the presence of the first catalyst so that the first raw material is hydrolyzed. Thereafter, a siloxane polymer is produced via condensation polymerization. In this way, a solution containing the siloxane polymer is obtained. In the first sub-step, the third solution is preferably added to the second solution in an amount such that the amount of the first catalyst with respect to the first raw material is 0.001 weight % to 0.1 weight %.

In the first sub-step, the amount of water in the third solution and/or the amount of third solution added to the second solution is/are preferably adjusted such that 10 parts by weight to 55 parts by weight of water is added with respect to 100 parts by weight of the first raw material. An added amount of water which is less than 10 parts by weight with respect to 100 parts by weight of the first raw material is not preferable, because such an amount decreases the rate of the polymerization reaction of first raw material. An added amount of water which is greater than 55 parts by weight with respect to 100 parts by weight of the first raw material is not preferable, because such an amount causes the polymerization reaction of the first raw material to occur too rapidly, which causes rapid gelation of the siloxane polymer solution that is produced.

In the first sub-step, the siloxane polymer is produced in a manner so as to have a weight-average molecular weight of preferably 1000 to 30000, more preferably 1000 to 20000, even more preferably 2000 to 20000, and even more preferably 3000 to 12000. The weight-average molecular weight being in these ranges makes it possible to increase the density of a silicone coating film to be formed. A weight-average molecular weight of less than 1000 can result in (i) failure to form a coated film from which high-density carbon nanotubes can be obtained or (ii) failure to form a uniform coated film. A weight-average molecular weight of more than 30000 can result in gelation of the siloxane polymer solution within a short period (for example, within 12 hours). A weight-average molecular weight of more than 30000 is therefore not preferable in cases where long term storage (preferably 1 week at room temperature, more preferably 6 months or longer at room temperature) is desired.

The weight-average molecular weight of the siloxane polymer can be controlled by, for example, controlling at least one of the following: concentration of the first raw material, temperature of polymerization reaction, length of time of polymerization reaction, and amount of water added. For example, for an alkoxysilane condensation reaction to take place, it is necessary for alkoxysilane units to be close to each other, within a distance (region) for which reaction can take place. A low concentration of the first raw material makes it less likely that alkoxysilane units will be close to each other and therefore reduces the reaction rate. Conversely, a high concentration of the first raw material increases the reaction rate, because alkoxysilane units are close to each other and able to react with each other rapidly. However, even when there is a high concentration of the first raw material, as the reaction progresses, alkoxysilane units react to produce the siloxane oligomer (siloxane polymer), thus reducing the concentration of the first raw material. This gradually reduces the rate of the alkoxysilane condensation reaction. For example, with regard to the solid content of siloxane polymer in the siloxane polymer solution 1 described in Production Example 1 of Example 2, a solid content of 10% to 20% tends to cause a slow reaction rate, a solid content of 30% to 40% tends to cause a moderate increase in reaction rate, and a solid content of not less than 50% tends to cause a large increase in reaction rate.

An increase in the temperature of a reaction solution causes increased movement of a reactive monomer (i.e., the reactive monomer becomes more likely to move). As such, thermal energy increases the kinetic energy of the alkoxysilane, thereby making it more likely that alkoxysilane units will move to a region for which reaction is likely, and thus making it easier for the reaction to progress. For example, in a case where the temperature of the siloxane polymer solution 1 during reaction is not more than 20° C., the reaction rate tends to be extremely slow. For temperatures of 30° C. to 50° C., the reaction rate tends to increase moderately along with an increase in temperature. For temperatures of 80° C. or more, the reaction rate tends to be very fast.

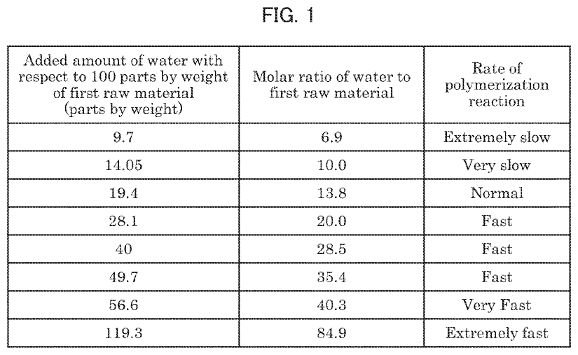

Regarding the amount of water added, as can be seen from the later-described FIG. 1, water causes hydrolysis (═Si—OR→═Si—H) to progress, such that highly reactive silanol (═Si—OH) is generated. The silanols form siloxane bonds (═Si—O—Si═). A larger amount of water correlates to faster progression of the reactions and thus a greater likelihood of polymerization. Note that prior to hydrolysis, the alkoxysilane compound and/or low condensate of the alkoxysilane compound which are used as raw materials have poor compatibility with water. As such, to achieve uniform hydrolysis, it is preferable to add these raw materials dropwise over a certain period of time while performing stirring.

In this way, achieving an appropriate reaction rate by controlling e.g. at least one of the concentration of the first raw material, the temperature of polymerization reaction, the length of time of polymerization reaction, and the amount of water added makes is possible to appropriately carry out the second sub-step such that the siloxane polymer has a desired weight-average molecular weight.

A molecular weight distribution (PDI (=Mw/Mn)) is preferably 1.2 to 6.0 and particularly preferably not more than 4.5. A molecular weight distribution of greater than 6.0 leads to (i) a large remaining un-reacted monomer component, which makes it impossible to form a coated film from which high-density carbon nanotubes can be obtained, or (ii) solubility into the solvent decreasing and gelation occurring along with polymerization, which makes it impossible to form a film. Note that the weight-average molecular weight (Mw) and number-average molecular weight (Mn) of polymers were measured by gel permeation chromatography (GPC), using the method described later in the Examples.

The second sub-step when preparing the first solution used in an embodiment of the present invention is a sub-step of removing the first catalyst from the solution prepared in the first sub-step, so that the first solution is obtained. A method used for removing the first catalyst in the second sub-step is not particularly limited. Possible examples of this method include adding an anion exchange resin to the solution prepared in the first sub-step. For example, in a case where the first catalyst is sulfuric acid, adding an anion exchange resin to the solution prepared in the first sub-step makes it possible to remove sulfuric acid ions SO₄²⁻.

Removing the first catalyst from the solution prepared in the first sub-step makes it possible to control polymerization of the first raw material (i.e., to end the reaction of the first sub-step). This makes it possible to control gelation of the siloxane polymer solution and produce a stable first solution.

Film Formation Step

Discussed next is the film formation step, in which a silicone coating film is formed on a surface of a base material by applying the siloxane polymer solution (first solution) to the base material and curing the siloxane polymer. The film formation step includes third through sixth sub-steps described below. In Embodiment 1, a thin stainless steel foil is used as the base material.

The third sub-step is a step of preparing a fourth solution containing a second catalyst which catalyzes curing of the siloxane polymer.

The second catalyst is preferably (i) a thermal-acid-generating agent which generates an acid upon heating or (ii) an photo-acid-generating agent which generates an acid upon irradiation with light. Possible examples of the thermal-acid-generating agent include amine-blocked p-toluenesulfonic acid, amine-blocked dodecylbenzenesulfonic acid, amine-blocked alkylnaphthalenesulfonic acid, and amine-blocked dialkylsulfosuccinic acid. Possible examples of the photo-acid-generating agent include sulfonium salt, iodonium salt, and dialkylsulfonyldiazomethane.

The fourth solution preferably contains a solid content adjusting agent (for example, n-propanol) in order to achieve a desired film thickness when applying a solution in the fourth step.

The fourth step is a step of applying to the base material a mixed solution containing the first solution and the fourth solution. The mixed solution can be applied via a known application method or printing method. For example, it is possible to utilize a spin coater, a gravure coater, a die coater, or screen printing. After application, the mixed solution may be subjected to a curing treatment.

The fifth step is a step of firing the mixed solution applied to the base material so that the silicone coating film is formed. Specifically, the silicone coating film is formed by carrying out firing at a temperature of 500° C. to 800° C., for 5 minutes to 30 minutes.

As described above, the third solution contains the second catalyst which catalyzes curing of the siloxane polymer. As such, carrying out firing makes it possible to form the silicone coating film with an even higher density.

The sixth sub-step is a step of forming a catalyst layer on the silicone coating film. In Embodiment 1, the catalyst layer is constituted by iron (Fe) and is formed by, for example, an electron beam (EB) method. Note, however, that the catalyst layer is not limited to being Fe. The catalyst layer may be constituted by, for example, cobalt (Co) or nickel (Ni). Furthermore, the catalyst layer may be formed by, for example, sputtering or vacuum deposition.

Thus, as described above, a method of producing the carbon nanotube growth substrate in accordance with Embodiment 1 includes the steps of: (a) preparing a first solution containing a siloxane polymer; and (b) forming a silicone coating film on a surface of a base material by applying the first solution to the base material and curing the siloxane polymer. This method involves forming the silicone coating film from the siloxane polymer and thus makes it possible to form a silicone coating film having high density. As a result, this method makes it possible to increase the yield of carbon nanotubes per unit area.

The present invention is not limited to the embodiments, but can be altered by a skilled person in the art within the scope of the claims. The present invention also encompasses, in its technical scope, any embodiment derived by combining technical means disclosed in differing embodiments.

### Example 1

The following description will discuss an Example of the present invention.

The present Example involved tests regarding the amount of water added with respect to 100 parts by weight of the first raw material, in the first sub-step of the step of preparing the first solution. In Example 1, an alkoxy siloxane oligomer (molecular weight: 1282) was used as the first raw material, and polymerization reactions were carried out under the conditions indicated in FIG. 1. FIG. 1 also shows data on the rate of the polymerization reaction.

As indicated in FIG. 1, in a case where water was added in an amount of 9.7 parts with respect to 100 parts by weight of the first raw material, the polymerization reaction was extremely slow. In a case where water was added in an amount greater than 56.6 parts by weight with respect to 100 parts by weight of the first raw material, the polymerization reaction was extremely fast, and during second sub-step, gelation occurred in the siloxane polymer solution produced. In particular, in a case where water was added in an amount of 119.3 parts by weight with respect to 100 parts by weight of the first raw material, the polymerization reaction was extremely fast, and gelation occurred rapidly. As such, the amount of water added with respect to 100 parts by weight of the first raw material is preferably 10.00 parts by weight to 55.00 parts by weight, more preferably 14 parts by weight to 50 parts by weight, and particularly preferably 14.05 parts by weight to 49.7 parts by weight.

### Example 2

Next, the carbon nanotubes of Production Examples 1 through 3 described below were produced, with use of the method of producing a carbon nanotube growth substrate in accordance with an embodiment of the present invention.

### Production Example 1: Siloxane Polymer 1

In Production Example 1, first, an ethyl silicate oligomer (product name: Silicate 45; manufactured by Tama Chemicals Co., Ltd.) and n-propanol (serving as a solvent) were added at a weight ratio of 100:130 to a four-neck flask. The four-neck flask was equipped with a stirrer, a dropping funnel, and a thermometer. Next, while stirring the solution at 25° C., the following were added dropwise over 1 hour, in the following amounts with respect to 100 parts by weight of the ethyl silicate oligomer: 0.25 parts by weight of 6N-sulfuric acid (first catalyst); 19.4 parts by weight of ion-exchange water; and 9.4 parts by weight of n-propanol. Thereafter, stirring was performed for 24 hours such that a siloxane polymer solution was obtained.

Next, in order to remove the sulfuric acid (first catalyst), to the siloxane polymer solution was added an anion exchange resin (product name: WA20; manufactured by Mistubishi Chemical Corporation), in an amount of 13.0 parts by weight with respect to 100 parts by weight of the ethyl silicate oligomer. Thereafter, stirring was performed for 5 minutes to 10 minutes, and pH test paper was used to confirm that pH was 5 to 6. Thereafter, the anion exchange resin was filtered out so that a clear and colorless siloxane polymer was obtained. Note that prior to use, the anion exchange resin had been treated with a 1N-NaOH solution, washed with water, and subsequently subjected to n-propanol substitution.

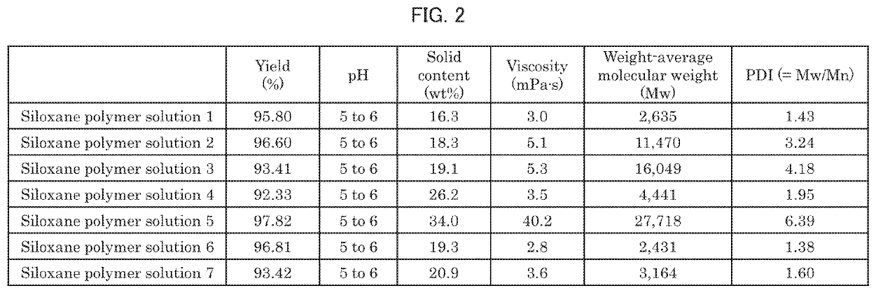

The siloxane polymer obtained was diluted in a DMF solution in which lithium bromide had been dissolved (10 mM LiBr). The diluted siloxane polymer was then measured by gel permeation chromatography (GPC) with use of the DMF solution as an eluent. As a result, it was found that the siloxane polymer had a weight-average molecular weight of 2635. FIG. 2 shows data on physical properties of the solution containing the siloxane polymer obtained (this solution referred to as a “siloxane polymer solution 1”). Note that the “yield” indicated in FIG. 2 is a value obtained by dividing (i) the weight of the siloxane polymer solution obtained by (ii) the weight of all added materials (for example, the first raw material, the solvent, the first catalyst, the ion exchange water). A decrease in yield may be caused by, for example, adsorption of a polymer component by the ion exchange resin, or volatilization of the solvent. A decrease in yield may also be caused by an unwanted reaction occurring in the process of producing the siloxane polymer solution. As such, a yield of not less than 90% is preferable.

Next, solid content of the siloxane polymer solution obtained was adjusted with n-propanol. A film was then formed by using a spin coater to apply the siloxane polymer solution to a stainless steel foil, in a manner such that a film thickness after curing would be approximately 450 nm. After the application, a curing treatment was carried out for 5 minutes at 200° C. The film formation and curing treatment were similarly carried out on an opposite surface of the stainless steel foil.

Next, the stainless steel foil was subjected to firing for 15 minutes at 700° C., so as to obtain a carbon nanotube growth substrate on which a silicone coating film was formed. No cracks had occurred in the silicone coating film of the carbon nanotube growth substrate thus obtained. Next, EB vapor deposition was used to form an Fe film of approximately 3 nm in thickness on the silicone coating film.

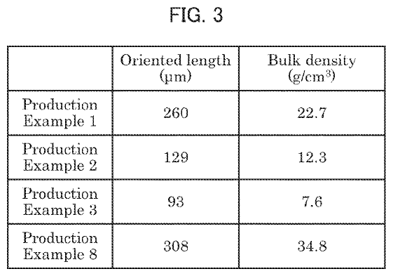

Next, chemical vapor deposition was used to grow carbon nanotubes on the carbon nanotube growth substrate. Specifically, the carbon nanotube growth substrate was heated to 660° C. in a chamber while supplying nitrogen gas into the chamber. Thereafter, while the temperature of 660° C. was maintained, carbon nanotubes were grown while supplying acetylene gas into the chamber. FIG. 3 shows data regarding the carbon nanotubes thus grown.

### Production Example 2: Siloxane Polymer 2

In Production Example 2, first, an ethyl silicate oligomer (product name: Silicate 45; manufactured by Tama Chemicals Co., Ltd.) and n-propanol (serving as a solvent) were added at a weight ratio of 100:130 to a four-neck flask. The four-neck flask was equipped with a stirrer, a dropping funnel, a reflux tube, and a thermometer. Next, while stirring the solution at 25° C., the following were added dropwise over 1 hour, in the following amounts with respect to 100 parts by weight of the ethyl silicate oligomer: 0.25 parts by weight of 6N-sulfuric acid (first catalyst); 19.4 parts by weight of ion-exchange water; and 9.4 parts by weight of n-propanol. Thereafter, reflux was performed for 8 hours while maintaining temperature with use of an oil bath set so that the system would reach a temperature of 80° C. In this way, a siloxane polymer solution was obtained.

Next, in order to remove the sulfuric acid (first catalyst), to the siloxane polymer solution was added an anion exchange resin (product name: WA20; manufactured by Mistubishi Chemical Corporation), in an amount of 13.0 parts by weight with respect to 100 parts by weight of the ethyl silicate oligomer. Thereafter, stirring was performed for 5 minutes to 10 minutes, and pH test paper was used to confirm that pH was 5 to 6. Thereafter, the anion exchange resin was filtered out so that a clear and colorless siloxane polymer was obtained. Note that prior to use, the anion exchange resin had been treated with a 1N—NaOH solution, washed with water, and subsequently subjected to n-propanol substitution.

The siloxane polymer obtained was diluted in a DMF solution in which lithium bromide had been dissolved (10 mM LiBr). The diluted siloxane polymer was then measured by gel permeation chromatography (GPC) with use of the DMF solution as an eluent. As a result, it was found that the siloxane polymer had a weight-average molecular weight of 11470. FIG. 2 shows data on physical properties of the solution containing the siloxane polymer obtained (this solution referred to as a “siloxane polymer solution 2”).

Subsequent steps were similar to those carried out for Production Example 1. FIG. 3 shows data regarding the carbon nanotubes of Production Example 2. No cracks had occurred in the silicone coating film of the carbon nanotube growth substrate thus obtained.

### Production Example 3: Siloxane Polymer 3

In Production Example 3, first, an ethyl silicate oligomer (product name: Silicate 45; manufactured by Tama Chemicals Co., Ltd.) and n-propanol (serving as a solvent) were added at a weight ratio of 100:78 to a four-neck flask. The four-neck flask was equipped with a stirrer, a dropping funnel, a reflux tube, and a thermometer. Next, while stirring the solution at 25° C., the following were added dropwise over 1 hour, in the following amounts with respect to 100 parts by weight of the ethyl silicate oligomer: 0.25 parts by weight of 6N-sulfuric acid (first catalyst); 14.1 parts by weight of ion-exchange water; and 43.2 parts by weight of n-propanol. Thereafter, reflux was performed for 24 hours while maintaining temperature with use of an oil bath set so that the system would reach a temperature of 80° C. In this way, a siloxane polymer solution was obtained.

Next, concentration of the siloxane polymer solution was adjusted by adding n-propanol to the siloxane polymer solution, in an amount of 23 parts by weight with respect to 100 parts by weight ethyl silicate oligomer.

Next, in order to remove the sulfuric acid (first catalyst), to the siloxane polymer solution was added an anion exchange resin (product name: WA20; manufactured by Mistubishi Chemical Corporation), in an amount of 13.0 parts by weight with respect to 100 parts by weight of the ethyl silicate oligomer. Thereafter, stirring was performed for 5 minutes to 10 minutes, and pH test paper was used to confirm that pH was 5 to 6. Thereafter, the anion exchange resin was filtered out so that a clear and colorless siloxane polymer was obtained. Note that prior to use, the anion exchange resin had been treated with a 1N-NaOH solution, washed with water, and subsequently subjected to n-propanol substitution.

The siloxane polymer obtained was diluted in a DMF solution in which lithium bromide had been dissolved (10 mM LiBr). The diluted siloxane polymer was then measured by gel permeation chromatography (GPC) with use of the DMF solution as an eluent. As a result, it was found that the siloxane polymer had a weight-average molecular weight of 16049. FIG. 2 shows data on physical properties of the solution containing the siloxane polymer obtained (this solution referred to as a “siloxane polymer solution 3”).

### Production Example 4: Siloxane Polymer 4

In Production Example 4, first, an ethyl silicate oligomer (product name: Silicate 45; manufactured by Tama Chemicals Co., Ltd.) and n-propanol (serving as a solvent) were added at a weight ratio of 100:75 to a four-neck flask. The four-neck flask was equipped with a stirrer, a dropping funnel, a reflux tube, and a thermometer. Next, while stirring the solution at 25° C., the following were added dropwise over 1 hour, in the following amounts with respect to 100 parts by weight of the ethyl silicate oligomer: 0.25 parts by weight of 6N-sulfuric acid (first catalyst); 19.4 parts by weight of ion-exchange water; and 40.6 parts by weight of n-propanol. Thereafter, reflux was performed for 55 hours while maintaining temperature with use of a water bath set so that the system would reach a temperature of 40° C. In this way, a siloxane polymer solution was obtained.

Next, in order to remove the sulfuric acid (first catalyst), to the siloxane polymer solution was added an anion exchange resin (product name: WA20; manufactured by Mistubishi Chemical Corporation), in an amount of 13.0 parts by weight with respect to 100 parts by weight of the ethyl silicate oligomer. Thereafter, stirring was performed for 5 minutes to 10 minutes, and pH test paper was used to confirm that pH was 5 to 6. Thereafter, the anion exchange resin was filtered out so that a clear and colorless siloxane polymer was obtained. Note that prior to use, the anion exchange resin had been treated with a 1N-NaOH solution, washed with water, and subsequently subjected to n-propanol substitution.

The siloxane polymer obtained was diluted in a DMF solution in which lithium bromide had been dissolved (10 mM LiBr). The diluted siloxane polymer was then measured by gel permeation chromatography (GPC) with use of the DMF solution as an eluent. As a result, it was found that the siloxane polymer had a weight-average molecular weight of 4441. FIG. 2 shows data on physical properties of the solution containing the siloxane polymer obtained (this solution referred to as a “siloxane polymer solution 4”).

### Production Example 5: Siloxane Polymer 5

In Production Example 5, first, an ethyl silicate oligomer (product name: Silicate 45; manufactured by Tama Chemicals Co., Ltd.) and n-propanol (serving as a solvent) were added at a weight ratio of 100:46 to a four-neck flask. The four-neck flask was equipped with a stirrer, a dropping funnel, a reflux tube, and a thermometer. Next, while stirring the solution at 25° C., the following were added dropwise over 1 hour, in the following amounts with respect to 100 parts by weight of the ethyl silicate oligomer: 0.25 parts by weight of 6N-sulfuric acid (first catalyst); 19.4 parts by weight of ion-exchange water; and 25.0 parts by weight of n-propanol. Thereafter, reflux was performed for 55 hours while maintaining temperature with use of a water bath set so that the system would reach a temperature of 40° C. In this way, a siloxane polymer solution was obtained.

Next, in order to remove the sulfuric acid (first catalyst), to the siloxane polymer solution was added an anion exchange resin (product name: WA20; manufactured by Mistubishi Chemical Corporation), in an amount of 13.0 parts by weight with respect to 100 parts by weight of the ethyl silicate oligomer. Thereafter, stirring was performed for 5 minutes to 10 minutes, and pH test paper was used to confirm that pH was 5 to 6. Thereafter, the anion exchange resin was filtered out so that a clear and colorless siloxane polymer was obtained. Note that prior to use, the anion exchange resin had been treated with a 1N-NaOH solution, washed with water, and subsequently subjected to n-propanol substitution.

The siloxane polymer obtained was diluted in a DMF solution in which lithium bromide had been dissolved (10 mM LiBr). The diluted siloxane polymer was then measured by gel permeation chromatography (GPC) with use of the DMF solution as an eluent. As a result, it was found that the siloxane polymer had a weight-average molecular weight of 27718. FIG. 2 shows data on physical properties of the solution containing the siloxane polymer obtained (this solution referred to as a “siloxane polymer solution 5”).

### Production Example 6: Siloxane Polymer 6

In Production Example 6, first, an ethyl silicate oligomer (product name: Silicate 45; manufactured by Tama Chemicals Co., Ltd.) and n-propanol (serving as a solvent) were added at a weight ratio of 100:131 to a four-neck flask. The four-neck flask was equipped with a stirrer, a dropping funnel, a reflux tube, and a thermometer. Next, while stirring the solution at 25° C., the following were added dropwise over 1 hour, in the following amounts with respect to 100 parts by weight of the ethyl silicate oligomer: 0.25 parts by weight of 6N-sulfuric acid (first catalyst); 19.4 parts by weight of ion-exchange water; and 94.0 parts by weight of n-propanol. Thereafter, reflux was performed for 65 hours while maintaining temperature with use of a water bath set so that the system would reach a temperature of 60° C. In this way, a siloxane polymer solution was obtained.

Next, in order to remove the sulfuric acid (first catalyst), to the siloxane polymer solution was added an anion exchange resin (product name: WA20; manufactured by Mistubishi Chemical Corporation), in an amount of 13.0 parts by weight with respect to 100 parts by weight of the ethyl silicate oligomer. Thereafter, stirring was performed for 5 minutes to 10 minutes, and pH test paper was used to confirm that pH was 5 to 6. Thereafter, the anion exchange resin was filtered out so that a clear and colorless siloxane polymer was obtained. Note that prior to use, the anion exchange resin had been treated with a 1N-NaOH solution, washed with water, and subsequently subjected to n-propanol substitution.

The siloxane polymer obtained was diluted in a DMF solution in which lithium bromide had been dissolved (10 mM LiBr). The diluted siloxane polymer was then measured by gel permeation chromatography (GPC) with use of the DMF solution as an eluent. As a result, it was found that the siloxane polymer had a weight-average molecular weight of 2431. FIG. 2 shows data on physical properties of the solution containing the siloxane polymer obtained (this solution referred to as a “siloxane polymer solution 6”).

### Production Example 7: Siloxane Polymer 7

In Production Example 7, first, an ethyl silicate oligomer (product name: Silicate 45; manufactured by Tama Chemicals Co., Ltd.) and n-propanol (serving as a solvent) were added at a weight ratio of 100:131 to a four-neck flask. The four-neck flask was equipped with a stirrer, a dropping funnel, a reflux tube, and a thermometer. Next, while stirring the solution at 25° C., the following were added dropwise over 1 hour, in the following amounts with respect to 100 parts by weight of the ethyl silicate oligomer: 0.25 parts by weight of 6N-sulfuric acid (first catalyst); 19.4 parts by weight of ion-exchange water; and 94.0 parts by weight of n-propanol. Thereafter, reflux was performed for 76 hours while maintaining temperature with use of a water bath set so that the system would reach a temperature of 80° C. In this way, a siloxane polymer solution was obtained.

Next, in order to remove the sulfuric acid (first catalyst), to the siloxane polymer solution was added an anion exchange resin (product name: WA20; manufactured by Mistubishi Chemical Corporation), in an amount of 13.0 parts by weight with respect to 100 parts by weight of the ethyl silicate oligomer. Thereafter, stirring was performed for 5 minutes to 10 minutes, and pH test paper was used to confirm that pH was 5 to 6. Thereafter, the anion exchange resin was filtered out so that a clear and colorless siloxane polymer was obtained. Note that prior to use, the anion exchange resin had been treated with a 1N-NaOH solution, washed with water, and subsequently subjected to n-propanol substitution.

The siloxane polymer obtained was diluted in a DMF solution in which lithium bromide had been dissolved (10 mM LiBr). The diluted siloxane polymer was then measured by gel permeation chromatography (GPC) with use of the DMF solution as an eluent. As a result, it was found that the siloxane polymer had a weight-average molecular weight of 3164. FIG. 2 shows data on physical properties of the solution containing the siloxane polymer obtained (this solution referred to as a “siloxane polymer solution 7”). The siloxane polymer solution 5 had a high weight-average molecular weight (Mw) of 27718, and exhibited gelation sooner than the siloxane polymer solutions of the other Production Examples. For the other Production Examples, with refrigerated storage, no gelation was observed even after a week.

Subsequent steps were similar to those carried out for Production Example 1. FIG. 3 shows data regarding the carbon nanotubes of Production Example 3. No cracks had occurred in the silicone coating film of the carbon nanotube growth substrate thus obtained.

### Production Example 8

In Production Example 8, amine-blocked p-toluenesulfonic acid (product name: NACURE2500; manufactured by KING INDUSTRIES), which is a thermal-acid-generating agent, was added as a curing catalyst (second catalyst) to the siloxane polymer prepared in Production Example 1 (the siloxane polymer 1). The amine-blocked p-toluenesulfonic acid was added in an amount of 0.1 wt % with respect to the solid content of siloxane polymer. Next, solid content was adjusted with n-propanol. A film was then formed by using a spin coater to apply the solution to a stainless steel foil, in a manner such that a film thickness after curing would be approximately 450 nm. After the application, a curing treatment was carried out for 5 minutes at 200° C. The film formation and curing treatment were similarly carried out on an opposite surface of the stainless steel foil.

Next, the stainless steel foil was subjected to firing for 15 minutes at 700° C., so as to obtain a carbon nanotube growth substrate on which a silicone coating film was formed. No cracks had occurred in the silicone coating film of the carbon nanotube growth substrate thus obtained. Next, EB vapor deposition was used to form an Fe film of approximately 3 nm in thickness on the silicone coating film.

Next, chemical vapor deposition was used to grow carbon nanotubes on the carbon nanotube growth substrate. Specifically, the carbon nanotube growth substrate was heated to 660° C. in a chamber while supplying nitrogen gas into the chamber. Thereafter, while the temperature of 660° C. was maintained, carbon nanotubes were grown while supplying acetylene gas into the chamber. FIG. 3 shows data regarding the carbon nanotubes thus grown. Note that the bulk density of carbon nanotubes is calculated from, for example, (i) the mass per unit area (unit: mg/cm²) of the carbon nanotubes and (ii) carbon nanotube length (measured by scanning electron microscope (SEM, manufactured by JEOL Ltd.) or a contactless film thickness measuring apparatus (manufactured by Keyence Corporation)).

As indicated in FIG. 3, using the carbon nanotube growth substrate produced via the method in accordance with an embodiment of the present invention makes it possible to grow carbon nanotubes having a long oriented length and a high bulk density. In other words, such a carbon nanotube growth substrate resulted in a high yield of carbon nanotubes per unit area.

1. A method of producing a carbon nanotube growth substrate, comprising the steps of:
(a) preparing a first solution containing a siloxane polymer; and
(b) forming a silicone coating film on a surface of a base material by applying the first solution to the base material and curing the siloxane polymer.

2. The method according to claim 1, wherein the step (a) includes the sub-steps of:
(c) preparing a solution containing the siloxane polymer by adding, to a second solution containing an alkoxysilane compound and/or a low condensate of the alkoxysilane compound, a third solution containing a first catalyst which catalyzes polymerization of the alkoxysilane compound and/or the low condensate of the alkoxysilane compound, so that the alkoxysilane compound and/or the low condensate of the alkoxysilane compound is polymerized; and
(d) removing the first catalyst from the solution prepared in the sub-step (c) so that the first solution is obtained.

3. The method according to claim 1, wherein in the step (a), the siloxane polymer is produced in a manner so as to have a weight-average molecular weight of 1000 to 20000.

4. The method according to claim 2, wherein in the sub-step (c), water is added in an amount of 14 parts by weight to 50 parts by weight with respect to a total of 100 parts by weight of the alkoxysilane compound and the low condensate of the alkoxysilane compound.

5. The method according to claim 1, wherein the step (b) includes the sub-steps of:
(e) preparing a fourth solution containing a second catalyst which catalyzes curing of the siloxane polymer;
(f) applying, to the base material, a mixed solution containing the first solution and the fourth solution;
(g) firing the mixed solution applied to the base material so that the silicone coating film is formed; and
(h) forming a catalyst layer on the silicone coating film.
